(19) United States
(12) Patent Application Publication
(10) Pub. No.: US 2022/0010913 A1
(43) Pub. Date: Jan. 13, 2022

(54) METHOD FOR RENOVATING DAMAGED LINE WALLS IN THE REGION OF THE CONNECTION OF AN AUXILIARY LINE TO A MAIN LINE

(71) Applicant: SML VERWALTUNGS GMBH, Rohrbach (DE)

(72) Inventor: CHRISTIAN NOLL, LIMBURGERHOF (DE)

(73) Assignee: SML VERWALTUNGS GMBH, Rohrbach (DE)

(21) Appl. No.: 17/294,452

(22) PCT Filed: Nov. 15, 2018
(86) PCT No.: PCT/DE2018/100936

§ 371 Date: May 17, 2021

(51) Int. Cl. F16L 55/1645; F16L 55/179

(52) U.S. Cl. CPC F16L 55/16455; F16L 55/179

(57) ABSTRACT

The present invention relates to a method for renovating damaged pipe walls in the region of the connection of a secondary pipe to a main pipe, comprising the following steps, in particular in this sequence:
a) providing an apparatus comprising a mobile carrier element, wherein a covering element which is variable in terms of outer diameter and an expandable expansion body are arranged on the carrier element;
b) moving the carrier element to the region to be renovated, which comprises the main pipe and the secondary pipe;
c) expanding the covering element until it lies against the inner wall of the main pipe, wherein the expansion body, before and/or at least intermittently during the expansion thereof, is arranged in a first recess of the covering element;
d) expanding the expansion body, such that the expansion body, when expanded, lies against the wall of the secondary pipe such that the covering element and the expansion body together form a shuttering;
e) positioning a transport means for a renovation compound on the second recess of the covering element; and
f) introducing the curable, viscous renovation compound into the space between the shuttering and the walls of the main and secondary pipes adjacent to the shuttering by means of the transport means from a storage device.

The present invention relates to methods for renovating damaged pipe walls in the region of the connection of a secondary pipe to a main pipe, wherein a covering element and a shuttering are placed simultaneously.

The prior art has disclosed apparatuses and methods for such a renovation, in the case of which a sewer renovation robot which is self-propelling or is movable by means of ropes in the sewer comprises a carrying apparatus for various renovation tools. Said tools, in particular a spatula device, can be controlled from outside the sewer after the robot is positioned in the region of the damaged area.

Moreover, for the repair of damaged areas in the region of the connection of a secondary pipe to a main pipe, apparatuses are described in the prior art, in the case of which the sewer renovation robot which can be arranged in the main sewer forms a carrying apparatus for a covering which can be placed onto the wall of the main pipe in the region of the secondary sewer connection.

The covering, for its part, carries an expandable expansion body, also called balloon, which can be introduced into the secondary pipe. When expanded, said expansion body lies against the wall of the secondary pipe and then, together with the covering, forms a shuttering which supports a viscous sealing compound, introduced into said shuttering, before said sealing compound is cured. After the curing, the expansion body is contracted and the covering is removed and the sealing compound forms the restored, previously damaged sewer wall regions. Such a covering according to the prior art, also referred to as shuttering sleeve, is basically already known in an embodiment from WO 1995027167A1.

There is the possibility in principle of supplying the viscous, curable sealing compound, which is used by the apparatuses of the type described, from the exterior of the sewer to the sewer renovation unit via tubes or other movable pipes.

However, this solution is not only complicated but also disadvantageous in a variety of respects. The retracing of pipes restricts the maneuverability of the apparatus in the sewer considerably, in particular since often a plurality of damaged areas to be renovated occur in a sewer and the damaged areas may also be located more than 100 meters away from the site at which the sewer renovation robot is introduced. The supply pipes for the spatula compound or sealing compound therefore have to be very long.

Pressing the viscous renovation compound through such long pipes causes considerable problems. Viscous, in particular thixotropic media cause a speed-dependent loss of pressure during each movement in the pipe. The numerical values for viscosity and shearing stress in the renovation compound vary greatly with the pipe geometry, the temperature and the precise state of the renovation compound which frequently contains granular components.

Particularly when the apparatuses operate with shutterings, it is particularly important to maintain certain pressure ranges during the pressing of the renovation compound. The pressure basically has to be at least high enough to ensure that the renovation compound completely fills all of the defective sewer wall regions. However, the pressure must not be so high that it subjects the damaged and fragile sewer wall regions to an excessive load.

Since the operator generally sits dozens of meters away, it is generally too much to expect the operator to set the conveying pressure for the renovation compound in such a manner that said compound arrives at the required pressure in the region of the spatula device or the shuttering formed by a covering and an expansion body.

Solutions are therefore known from the prior art in order to dispense with use of pipes for supplying the renovation compounds.

DE 36 18 963 discloses a sewer renovation apparatus which is equipped with a covering and expansion body and in which the renovation compound is arranged around the initially slack expansion body and is then driven together therewith into the secondary sewer. When the expansion body expands, it presses the renovation compound radially against the damaged sewer wall.

The drawback of this is that only renovation compounds with a long pot life can be used. Pot life is understood as meaning the processability duration of reactive materials. It is therefore the time between starting to mix a multi-component substance and the end of the processability thereof, i.e. the period of time in which the substance can still be taken out of the pot and processed.

Since two-component adhesives are customarily used as the renovation compound, it is therefore the case in a solution according to DE 36 18 963 that the time until curing has to be defined with a good deal of certainty so that it is ensured that the shuttering has set prior to the end of the pot life.

It has therefore alternatively been disclosed in the prior art to arrange the renovation compound directly on the renovation robot in cartridges, cylinders and storage containers, which can be emptied by means of pumps.

However, a problem with this is that it extends the necessary pot life. When storage containers are used, the renovation compound begins to cure at the latest when the storage containers are filled therewith and therefore already before the renovation robot is introduced into the pipe to be renovated.

It should be noted here that the fitting of the shuttering comprises a plurality of working steps. First of all, the covering element is expanded in the main pipe, then the expansion body is introduced through a recess into the secondary pipe and likewise expanded by a small needle-shaped connecting element having to be introduced into the valve of the expansion body. Subsequently, a closure in the covering has to be opened, and the outlet of a pipe for transporting the renovation compound has to be pressed there into the intermediate space between the shuttering, formed by the covering and the expansion body, and the existing walls.

Each of said working steps is potentially error-prone and possibly has to be repeated several times, and therefore the pot life has to be configured with a high degree of certainty for such operating errors. The curing time of the renovation compound until the shuttering can be removed again is correspondingly long.

However, it is desirable to minimize the period of time in which the shuttering has to remain in the pipe. This reduces working costs and also the costs for keeping the sewer renovation robot ready.

The known apparatuses therefore have the disadvantage that, although the omission of external supply pipes for the renovation compound make it possible to minimize the correct pressurization problems, a long curing time is necessary since the renovation compound carried along has to have a pot life of sufficient length.

The setting of the expansion body is particularly cumbersome here. In order to expand the expansion body, this must be charged with compressed air. The valve of the expansion body is however small and must be precisely controlled by means of a boom by virtue of a connecting element, normally in needle form, being introduced into said valve. This connection is difficult for a user who is controlling the boom by means of camera images, and often requires several attempts. In the worst case, the expansion body is even destroyed in the process. A long pot life of the renovation compound must be selected specifically also owing to this time-consuming expansion of the expansion body. Whereas the time taken to drive the apparatus to the area to be renovated can be determined relatively accurately, the number of attempts until the expansion body is expanded is difficult to predict, and corresponding certainty periods must be planned in.

It was therefore the object of the present invention to overcome the disadvantages of the prior art and in particular to supply an apparatus permitting more rapid and more reliable renovation of pipes, wherein as rapid a curing as possible of the renovation compound is made possible.

This object is achieved by a method for renovating damaged pipe walls in the region of the connection of a secondary pipe to a main pipe, comprising the following steps, in particular in this sequence:
a) providing an apparatus comprising a mobile carrier element, wherein a covering element which is variable in terms of outer diameter and an expandable expansion body are arranged on the carrier element;
b) moving the carrier element to the region to be renovated, which comprises the main pipe and the secondary pipe;
c) expanding the covering element until it lies against the inner wall of the main pipe, wherein the expansion body, before and/or at least intermittently during the expansion thereof, is arranged in a first recess of the covering element;
d) expanding the expansion body, such that the expansion body, when expanded, lies against the wall of the secondary pipe such that the covering element and the expansion body together form a shuttering;
e) positioning a transport means for a renovation compound on the second recess of the covering element; and
f) introducing the curable, viscous renovation compound into the space between the shuttering and the walls of the main and secondary pipes adjacent to the shuttering by means of the transport means from a storage device.

A carrier element is intended to be understood as meaning in particular an element which is movable on wheels or chains and has an integrated drive. Alternatively to an integrated drive, the carrier element can also be moved in the pipe by means of ropes, cables and the like.

The provision of such a carrier element as per step a) thus serves for the transport and operation of the elements required for the renovation, in particular for the transport of the shuttering systems covering element and of the expansion body and of the renovation compound.

In step b), the carrier element with all required elements is conveyed to the section to be renovated. Subsequently, according to the invention, in a step c), the covering element is transferred from its relatively small transport state into its operating state, whilst at the same time the expansion body remains in the first recess of the covering element.

A covering element is intended to be understood as meaning an element which can cover the inner wall of the main pipe in such a manner that a defined cavity is formed between the covering element and the space located therebehind, the cavity being sealed in relation to the renovation compound and preventing penetration of the latter into the main pipe.

It has frequently proven advantageous to provide the covering element in the form of a hollow cylinder, the inside diameter of which can be changed. The hollow cylinder is thus moved in a transport state with a reduced inside diameter by means of the carrier element to the damaged area and then expands there such that it lies fixedly against the inner walls of the main pipe.

The formation of the covering element with different inside diameters is advantageous and is known from the prior art. In particular, formation of the covering element in the form of a shuttering sleeve has the advantage that the cylindrical covering element can be very readily transported in the pipe and is fixed very securely in the operating state since it can be automatically aligned within the main pipe and arrested in the desired position by means of the contact pressure without further aids having to be used.

An expansion body is intended to be understood as meaning a variable-size element which is generally based on plastic or rubber and basically resembles a balloon. Furthermore, the expansion body comprises in particular a valve in order to permit expansion with compressed air and, when the valve is opened, to permit subsequent contraction.

According to the invention, the expansion body is arranged here in the first recess in the covering element and expands into the secondary pipe as per step d). Here, according to one embodiment of the present invention, step d) may already be performed entirely or at least intermittently upon step c), but obviously also after step c).

As already stated, it is the case in particular that the setting of the expansion body, that is to say the arrangement thereof in the secondary pipe through the first recess and the expansion thereof, is difficult for a user. By virtue of the expansion body being placed together with the shuttering and equally directly expandable, the transfer of the apparatus according to the invention from the transport state into the operating state is made easier, more reliable and faster.

The covering element and the expansion body together form a shuttering which corresponds, at least approximately, to the inside diameter of the pipes.

The renovation compound can subsequently be pressed via a second recess in the covering element into the cavity closed by the shuttering. After the renovation compound has cured, the shuttering is removed by the expansion body being contracted and removed from the first recess of the covering element. The covering element itself is subsequently contracted in order to be able to be removed from the main pipe.

The invention is based here on the surprising finding that simultaneous setting of covering element and expansion body significantly accelerates the renovation process. By virtue of the expansion body being arranged directly in the first recess, it is made possible here that said expansion body does not have to be retroactively arranged in the secondary pipe. Furthermore, it can be ensured that the connecting element is connected to the expansion body already prior to the renovation process in order to exert pressure on the expansion body. This considerably reduces the uncertainty in the transfer of the apparatus according to the invention from the transport state into the operating state, such that the renovation process is made more calculable. Based on the reduction of the described risks in the placement of the expansion body, it is equally possible for the pot life of the renovation compound to be reduced, and thus for the entire curing process to be accelerated.

Here, the method according to the invention thus not only reduces the risk of damage to the expansion body but, in parallel, accelerates the entire renovation process owing to the shorter pot life and thus shorter curing duration of the renovation compound.

In step e), it is then the case that a transport means for the renovation compound is positioned on the second recess of the covering element, and subsequently, the renovation compound is, in step f), filled into the cavity formed by the shuttering.

Here, it may be provided according to the invention that a boom is included which is mounted so as to be movable in at least one spatial axis and which moves the expansion body in a radial direction during the expansion of the covering element, such that the expansion body is arranged in the first recess before and/or at least intermittently during the expansion of the covering element.

According to the invention, it may prove advantageous if the boom is mounted so as to be movable in at least two, in particular in three, spatial axes, and is moved in particular by means of an actuator, preferably by means of an electric motor and/or at least one linear actuator.

A movement of the boom by means of an actuator, for example an electric motor or a hydraulic or pneumatic cylinder, is particularly advantageous, because the boom is thus provided in the form of a robot arm that can be controlled remotely by a user.

It may furthermore be preferred that the movement of the boom in at least one spatial axis is performed by means of a control device automatically in a manner dependent on the expansion of the covering element.

In order to make it possible that the expansion body remains at least in sections within the first recess during the transfer of the covering element from its transport state into the operating state, it may be provided that the expansion movement of the covering element is coupled to a movement of the first boom in at least a radial direction. The movement of the covering element is known, measurable and/or controllable, such that an automated adaptation of the position of the expansion body can be easily realized. The expansion body thus also optionally remains in the desired position without active interventions by the user.

Furthermore, it may be advantageous that a compressed-air-generating element, in particular in the form of a compressor and/or a compressed-air container, is provided, which is arranged on the carrier element in order to expand the expansion body by means of compressed air.

It may be provided here in particular that the expansion body comprises a valve which is arranged in the region of the first recess and/or in the interior of the covering element, wherein the boom which is mounted so as to be movable at least in one spatial axis is used for guiding a transport pipe for the compressed air from the carrier element. Here, the transport pipe, on the side opposite the compressed-air-generating element, comprises a connecting element which can be brought into or is in operative connection with the valve of the expansion body in order, by means of the compressed-air-generating element, to charge and to expand the expansion body with compressed air.

For expanding and contracting the expansion body, use is preferably made of a valve which is integrated in the expansion body. The valve itself can either be charged with pressure by means of the connecting element or positive pressure in the expansion body can be let out of the expansion body by bringing the connecting element into operative connection with the valve.

An advantage of the present invention is realized in that precisely this complicated connection of connecting element and valve exists from the outset, and does not have to be retroactively generated manually for the first time in the pipe system.

In order to expand the connecting element, use is preferably made according to the invention of compressed air. The compressed air is either generated here in situ or carried along in a compressed-air container. In order to connect the connecting element to the valve of the expansion body, it has moreover proven advantageous for use to be made of a boom which is movable in at least one spatial axis and at the free end of which the connecting element is located. The connecting element is preferably connected here to the transport pipe for compressed air, said transport pipe being connected in turn to the compressed-air-generating element.

It may also be provided according to the invention that the renovation compound is introduced from the storage device by pressurization in the interior of the storage device, and/or by a pumping device, via the transport means into the space behind the shuttering.

The renovation compound has to be pressed under a respectively individual minimum pressure into the cavity defined by the shuttering. Furthermore, the pressure, however, must not be so high that the shuttering can no longer fulfil its sealing function. In order to be able to set a such defined pressure, pumping devices, for example peristaltic pumps or piston pumps, have proven particularly suitable. Alternatively, however, it can also be possible to permit a flow of the renovation compound into said cavity by means of pressurization within the storage device.

It can also be provided, according to an embodiment of the present invention, that the second recess is closed by means of a closure element, wherein in particular the closure element is openable and closeable by means of the carrier element and/or a further carrier element, wherein the further carrier element is mounted so as to be movable in at least one, in particular two, preferably three spatial axes.

Such a closure element is advantageous since the sealing compound which has not yet cured is therefore prevented from penetrating out through the second recess which, although small, is present.

It may also be provided that the transport means is connected to the carrier element or to the further carrier element such that the end of the transport means opposite the storage container can be arranged or is arranged on or at least partially in the second recess in order to introduce the renovation compound into the space between the shuttering and the walls of the main and secondary pipes adjacent to the shuttering.

Furthermore, in one embodiment, it may prove to be advantageous for a camera to be provided which is arranged on the carrier element, wherein the camera is arranged adjacent to the boom such that a position of the boom is displayed on a display device to a user.

According to the prior art, cameras are arranged on a boom which extends outside the actual carrier element. It has however been found that, because of the sight conditions, the distortion due to the external perspective and the light conditions, the boom can be moved by a user to in particular the relatively small valve of the expansion body and a closure element for the second recess only with a great deal of complexity. An arrangement of a camera, which is also intended, within the context of the present invention, to include a system of cameras or image capture devices, adjacent to the boom overcomes these disadvantages. Furthermore, a camera according to the invention can be brought into or can be in operative connection with a light source in order to permit an improved display of the objects to be manipulated by the user.

Here, it may be particularly advantageous that the position of the boom is automatically controlled in closed-loop fashion by means of an image processing device of the control device, and/or the position of the boom is controlled in open-loop fashion by a user by means of an input device.

According to the invention, it has proven advantageous if the image processing device is used to automatically control the valve of the expansion body, by virtue of the control device receiving corresponding control signals and controlling the at least one boom correspondingly. This applies equally to an opening and closing of the closure element of the second recess. Alternatively, it may also be provided that the image processing device assists the user in the control of the one or more booms by means of superposed overlays, highlights or reference lines or assistance elements.

It may furthermore be provided that, in one embodiment, the method according to the invention furthermore comprises the following steps, in particular in this sequence, preferably after step f):
g) contracting the expansion body, in particular by means of a connection of the connecting element of the boom, after the renovation compound has cured; and
h) contracting the covering element.

Finally, it may be provided that the method according to the invention furthermore comprises the following steps, in particular in this sequence, preferably after step h):
i) removing the expansion body and the covering element from the pipe by means of the carrier element after the renovation compound has cured.

It may also be provided that, according to one embodiment, a heating device is provided which is integrated in the covering element and/or in the transport means at least in the region of the second recess and/or is operatively connected to the covering element and/or to the transport means in the region of the second recess, and the transport means and/or the covering element and the renovation compound are heated for faster curing thereof during the introduction of the renovation compound and/or at least intermittently, in particular continuously, during the curing of the renovation compound.

It can be provided here in particular that the heating device is in the form of a heating tube, a radiation source, in particular an infrared heating apparatus and/or a microwave-generating device, and/or an electric heater.

A heating device is intended to be understood basically as meaning any heat-generating apparatus, the function of which consists primarily in generating the provision of thermal energy. Apparatuses which produce what is referred to as waste heat, for example lamps, electric motors and the like, are not understood as a heating device within the context of the invention.

The preferred heating devices have proven particularly advantageous here for heating up the renovation compound.

Further features and advantages of the invention emerge from the description below in which exemplary embodiments of the invention will be explained by way of example with reference to schematic drawings without thereby restricting the invention.

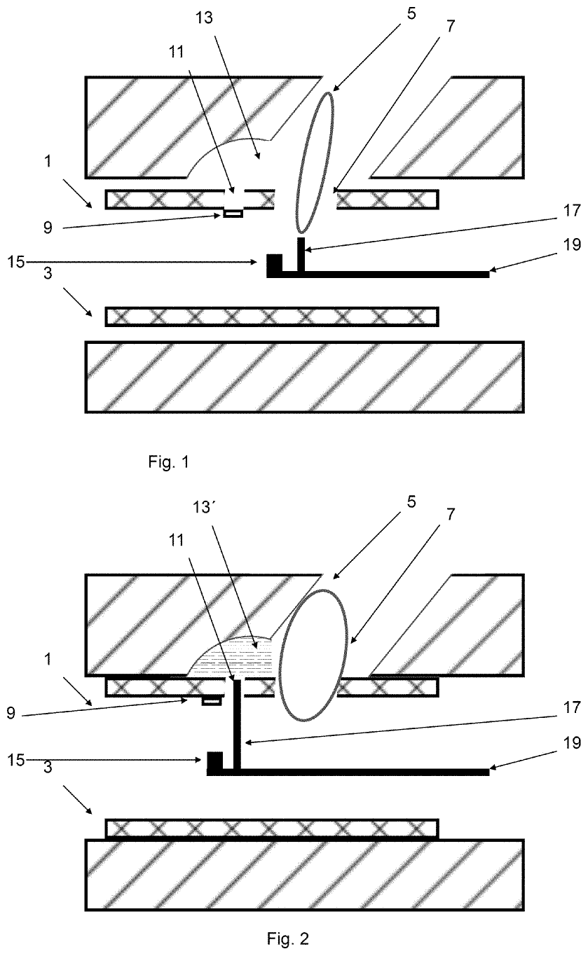

FIG. 1 shows a schematic view of a detail of an apparatus according to the invention and a shuttering system according to the invention in a pipe system in the transport state in section;

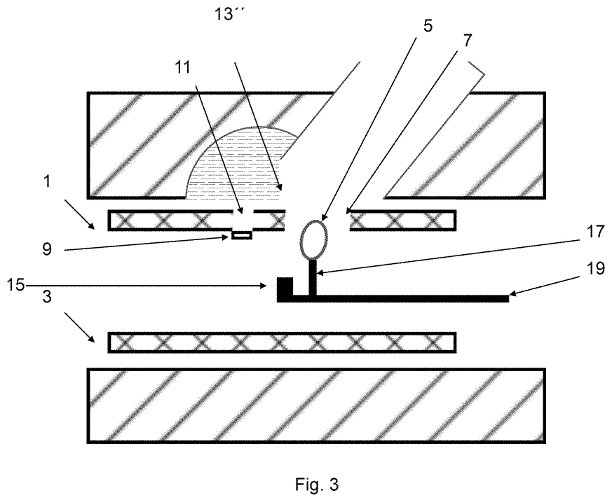

FIG. 2 shows a schematic view of a detail of an apparatus according to the invention and a shuttering system according to the invention in a pipe system in the operating state in section; and

FIG. 3 shows a schematic view of a detail of an apparatus according to the invention and a shuttering system according to the invention in a pipe system after renovation in section.

An exemplary apparatus 1 for an embodiment of a method according to the invention is only partially illustrated in the figures. For example, a chassis and a storage container for the renovation compound of the apparatus 1 are not shown.

FIG. 1 schematically illustrates a transport state of an apparatus according to the invention. The apparatus 1 comprises a covering element 3 and an expansion body 5. The covering element 3 here is in the form of a shuttering sleeve and the expansion body 5 is in the form of a balloon. The expansion body 5 is already partially arranged here in a first recess 7.

The apparatus 1 thus provided as per step a) is then, in a step b), moved to the area to be renovated, which comprises the main pipe and the secondary pipe.

When the apparatus 1 is situated at the working location, then as per step c), the covering element 3 is expanded as shown in FIG. 2, whilst the expansion body 5 remains in the first recess 7 and is moved radially outward, and possibly in one or two further spatial axes, correspondingly to the change in the position of the first recess 7.

The expansion body 5 is then likewise expanded, either during the expansion of the covering element 3 or after the completion of the expansion thereof, such that a shuttering is formed.

A closure element 9 closes a second recess 11 through which the renovation compound can be introduced into the cavity 13 closed by the expansion body 5 and the covering element 3, in order to renovate the damaged area in the pipe system.

The closure element 9 may initially be present in the opened state, or may first be opened directly prior to an introduction of the renovation compound into the cavity 13.

A camera 15 and a boom 17 are arranged here on a carrying arm 19 of the first apparatus 1, which is only partially shown.

As is apparent from FIG. 1, the covering element 3 is arranged at a distance from the inner wall of the main pipe and the expansion body 5 is already located in the first recess 7. Simple transport of the two shuttering elements to the portion of the pipe system to be renovated is thus made possible, whilst both elements can be directly expanded and transferred into the operating state without the need for a connection of the expansion body 5 to further devices or an introduction of said expansion body into the first recess 7.

FIG. 2 illustrates the operating state of the apparatus according to the invention. The covering element 3 is expanded here such that it lies firmly against the inner wall of the main pipe. The expanded expansion body 5 equally lies tightly in the secondary pipe against the inner wall of the secondary pipe. The cavity 13′ which is thus closed is filled with the renovation compound by means of the boom 17 through the second recess 11 which is exposed by opening of the closure element 9. Subsequently, the closure element 9 is closed and the renovation compound can cure.

In order to accelerate the curing, a heating apparatus (not shown) may be used. This can be arranged, for example, directly in the covering element 3 in the region of the second recess 11, or can be integrated in the transport means for the renovation compound. The heating apparatus can also be operatively connected to the covering element or to the transport means and not integrated directly therein.

After curing has taken place, the expansion body 5 is contracted and the outside diameter of the covering element 3 is also reduced, and therefore the shuttering formed from said two elements can be removed. The renovation compound 3.3″ is cured at this point and the renovation of the pipe has therefore been concluded successfully.

The features of the invention disclosed in the above description and the claims may be essential both individually and in any desired combination for implementing the invention in its various embodiments.

1. A method for renovating damaged pipe walls in the region of the connection of a secondary pipe to a main pipe, comprising the following steps, in particular in this sequence:
a) providing an apparatus comprising a mobile carrier element, wherein a covering element which is variable in terms of outer diameter and an expandable expansion body are arranged on the carrier element;
b) moving the carrier element to the region to be renovated, which comprises the main pipe and the secondary pipe;
c) expanding the covering element until it lies against the inner wall of the main pipe, wherein the expansion body, before and/or at least intermittently during the expansion thereof, is arranged in a first recess of the covering element;
d) expanding the expansion body, such that the expansion body, when expanded, lies against the wall of the secondary pipe such that the covering element and the expansion body together form a shuttering;
e) positioning a transport means for a renovation compound on the second recess of the covering element; and
f) introducing the curable, viscous renovation compound into the space between the shuttering and the walls of the main and secondary pipes adjacent to the shuttering by means of the transport means from a storage device.

2. The method as claimed in claim 1, characterized in that a boom is included which is mounted so as to be movable in at least one spatial axis and which moves the expansion body in a radial direction during the expansion of the covering element, such that the expansion body is arranged in the first recess before and/or at least intermittently during the expansion of the covering element.

3. The method as claimed in claim 2, characterized in that the boom is mounted so as to be movable in at least two, in particular in three, spatial axes, and is moved in particular by means of an actuator, preferably by means of an electric motor and/or at least one linear actuator.

4. The method as claimed in claim 2, characterized in that the movement of the boom in at least one spatial axis is performed by means of a control device automatically in a manner dependent on the expansion of the covering element.

5. The method as claimed in claim 1, characterized in that a compressed-air-generating element, in particular in the form of a compressor and/or a compressed-air container, is provided, which is arranged on the carrier element in order to expand the expansion body by means of compressed air.

6. The method as claimed in claim 5, characterized in that a transport pipe for transporting the compressed air from the compressed-air-generating element to the expansion body is arranged on the boom, wherein the transport pipe, on the side opposite the compressed-air-generating element, comprises a connecting element which can be brought into or is in operative connection with a valve of the expansion body in order, by means of the compressed-air-generating element, to charge and to expand the expansion body with compressed air.

7. The method as claimed in claim 1, characterized in that the renovation compound is introduced from the storage device by pressurization in the interior of the storage device, and/or by a pumping device, via the transport means into the space behind the shuttering.

8. The method as claimed in claim 1, characterized in that a camera is provided which is arranged on the carrier element, wherein the camera is arranged adjacent to the boom such that a position of the boom is displayed on a display device to a user.

9. The method as claimed in claim 8, characterized in that the position of the boom is automatically controlled in closed-loop fashion by means of an image processing device of the control device, and/or the position of the boom is controlled in open-loop fashion by a user by means of an input device.

10. The method as claimed in claim 1, furthermore comprising the following steps, in particular in this sequence, preferably after step f):
g) contracting the expansion body, in particular by means of a connection of the connecting element of the boom, after the renovation compound has cured; and
h) contracting the covering element.

11. The method as claimed in claim 10, furthermore comprising the following steps, in particular in this sequence, preferably after step h):
i) removing the expansion body and the covering element from the pipe by means of the carrier element after the renovation compound has cured.

12. The method as claimed in claim 1, characterized by providing a heating device which is integrated in the covering element and/or in the transport means at least in the region of the second recess and/or is operatively connected to the covering element and/or to the transport means in the region of the second recess, and heating the transport means and/or the covering element and the renovation compound for faster curing thereof during the introduction of the renovation compound and/or at least intermittently, in particular continuously, during the curing of the renovation compound.
